(19) United States
(12) Patent Application Publication
(10) Pub. No.: US 2018/0013618 A1
(43) Pub. Date: Jan. 11, 2018

(54) DOMAIN NAME SYSTEM SERVERS FOR DYNAMIC HOST CONFIGURATION PROTOCOL CLIENTS

(71) Applicant: Aruba Networks, Inc., Sunnyvale, CA (US)

(72) Inventor: Isaac Theogaraj, Bangalore (IN)

(21) Appl. No.: 15/478,854

(22) Filed: Apr. 4, 2017

(30) Foreign Application Priority Data
Jul. 11, 2016 (IN) 201641023731

(51) Int. Cl. H04L 12/24; H04L 29/06

(52) U.S. Cl. CPC H04L 41/0803; H04L 41/12; H04L 67/42

(57) ABSTRACT

In some examples, a method includes determining, with a Dynamic Host Configuration Protocol (DHCP) server, a primary Domain Name Service (DNS) server and a backup DNS server for a DHCP client in a network. In this method, the primary DNS server and the backup DNS server are automatically determined from a pool of DNS servers to provide a predetermined Quality of Experience (QoE) for the DHCP client based on dynamic network parameters of the network. The method can further include assigning, with the DHCP server, the primary and backup DNS servers to the DHCP client.

### BACKGROUND

The Dynamic Host Configuration Protocol (DHCP) is a network protocol that can be used to distribute certain network configuration parameters, such as Domain Name System (DNS) server addresses from a DHCP server. DNS is a hierarchical decentralized naming system for devices, computer services, or other resources connected to the Internet or a private network. DNS can rely on DNS servers to translate domain names to numerical IP addresses in order to locate and identify such resources. In some networks, a DHCP server may provide DNS server information to one or more clients within the network.

### BRIEF DESCRIPTION OF DRAWINGS

FIG. 1 is a diagram of a network environment including a DHCP server with a DNS server selection module, according to an example.

FIG. 2 is a flowchart for a method, according to an example.

FIG. 3 is a diagram of a computing device, according to an example.

FIG. 4 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As provided above, in some networks, a DHCP server may provide DNS server information to one or more clients within the network. In some situations, the DHCP server may provide a DHCP client with a preferred DNS server address as well as one or more backup DNS server addresses in case of failure of the preferred DNS server address. It has been found that the amount of time used to resolve a DNS address may have an impact on overall user experience. For example, DNS resolution may occur frequently as it may be used for every web page visited by a client. As a result, an improvement in a selection or use of primary and backup DNS servers may provide an improvement to an overall user experience for one or more clients on the network.

In some systems, an administrator may assign different DNS servers for different pools or subnets of DHCP clients or servers. This can, for example, be referred to as a static DNS server distribution system. In such a static DNS server distribution system, DHCP clients in different pools or subnets may be assigned to different DNS servers in order to provide static load balancing. However, in some situations, such a static system may be administratively burdensome, may rely on outdated information, and may not be optimized based on more relevant aspects of the network, such as response times of the DNS servers, types of DHCP clients, number of active clients on each DNS server, location of DHCP clients, etc.

Certain implementations of the present disclosure seek to address these and other issues by providing dynamic and efficient DNS server assignments. In some implementations, a method can include determining, with a DHCP server, a primary DNS server and a backup DNS server for a DHCP client in a network. The primary and backup DNS servers can, for example, be automatically determined from a pool of DNS servers so as to provide a predetermined Quality of Experience (QoE) for the DHCP client based on dynamic network parameters of the network. The method can further include assigning, with the DHCP server, the primary and backup DNS servers to the DHCP client. Certain implementations of the present disclosure may allow for improved DNS server load balancing based on relevant dynamic network parameters. Other advantages of implementations presented herein will be apparent upon review of the description and figures.

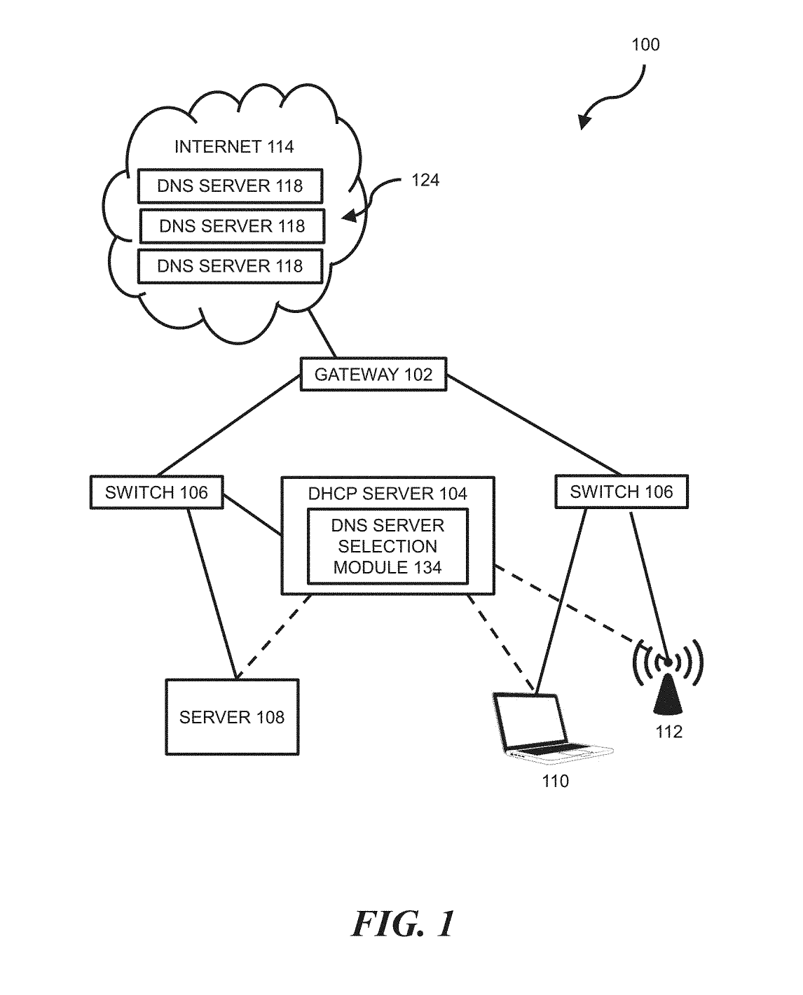

FIG. 1 is a diagram of an example network environment 100 that includes a local area network portion including a gateway 102, a DHCP server 104 including a DNS server selection module 134, which is described in further detail below, various switches 106, a server 108, an example end user device 110, and an Access Point (AP) 112. In environment 100, DHCP server 104 includes a DNS server selection module 134 as described in further detail below. The structure and functionality of the various aspects of environment 100 are described in further detail below.

As used herein, the term “DHCP” can refer to the Dynamic Host Configuration Protocol, which can be used to request Internet Protocol (IP) parameters, such as an IP address or DNS address for one or more remote or local DNS servers 118 within one or more pools 124 of DNS servers. When a DHCP client, such as server 108, end user device 110, or AP 112 (in some situations), connects to a network, DHCP software on the client can send a broadcast query requesting network information. A DHCP server (e.g., DHCP server 104) on the network can then service the request. In addition to other responsibilities, DHCP server 104 may manage a pool of IP addresses and information about client configuration parameters such as default gateway, domain name, name servers, and time servers. On receiving such a request, DHCP server 104 may respond with specific configuration parameters for each client valid for a lease time period. The client can, for example, query for such information immediately after booting, and/or periodically thereafter before the expiration of the parameters. When the DHCP client seeks to refresh an assignment, it may request the same parameter values. However, DHCP server 104 may assign a new address if appropriate based on assignment policies set by network administrators or other factors.

As used herein, the terms “Domain Name System” and “DNS” can refer to a hierarchical decentralized naming system for devices, computer services, or other resources connected to the Internet or a private network. DNS can rely on DNS servers, such as remote or local DNS servers 104, to translate domain names to numerical IP addresses. For example, the domain name www.example.com may translate to 93.184.216.119 for an IPv4 address and may translate to 2606:2800:220:6d:26bf:1447:1097:aa7 for an IPv6 address.

The functionality of DHCP server 104 or other network equipment within environment 100 can, for example, be implemented in part via a software program on a standalone machine, such as a standalone server. In some implementations, DHCP server 104 can be implemented on one or more multi-purpose machines, such as a suitable desktop computer, laptop, tablet, or the like. In some implementations, DHCP server 104 can be implemented on a suitable non-host network node, such as certain types of network switches. In some implementations, the functionality of DHCP server 104 can be implemented within the hardware and software of network equipment, such as a switch 106, AP 112, gateway 102, a network controller, etc. It is appreciated that the functionality of DHCP server 104 may be split among multiple servers or other devices. For example, environment 100 is described and illustrated as including only one DHCP server 104. However, it is appreciated that the disclosure herein can be implemented in networks with multiple DHCP servers. For example, in some networks, network devices are in communication with DHCP servers such that control of the network can be smoothly handed over from a first DHCP server to a second DHCP server if a first DHCP server fails or is otherwise out of operation. In some implementations, one or more DHCP servers 104 can operate in a distributed fashion over multiple appliances but present themselves as a single entity to the network.

As another example, multiple DHCP servers can be used to work together to concurrently service certain networks. In such networks, a first DHCP server can, for example, service certain network devices while a second DHCP server can service other network devices. In view of the above, reference in this application to a single DHCP server 104 that controls an operation of network devices in environment 100 is intended to also include such multiple controller configurations (and other suitable multiple controller configurations).

End user device 110 can, for example, be in the form of network hosts or other types of network nodes. End user device 110 is depicted as a laptop in FIG. 1, however it can be in the form of another suitable end user device, such as a mobile phone, tablet, laptop, desktop computer, printer, Internet of Things (IoT) device, etc. In certain implementations, end user device 110 can be in the form of a desktop computer including a monitor for presenting information to an operator and a keyboard and mouse for receiving input from an operator.

Various intermediary nodes within the network environment can, for example, be in the form of switches (e.g., switches 106) or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for the network. Gateway 102 can, for example, be in the form of a network node that acts as an entrance to another network, such as Internet 114 or another suitable Wide Area Network (WAN) or Local Area Network (LAN).

The various nodes within network environment 100 are connected via one or more data channels (shown in solid lines), which can, for example be in the form of wired data cables or wireless data channels. Although a single link (i.e., a single line in FIG. 1) between each network node is illustrated, it is appreciated that each single link may include multiple wires or other wired or wireless data channels. Moreover, FIG. 1 further depicts DHCP server 104 as being connected to server 108, end user device 110, and AP 112 via broken lines, which is intended to illustrate logical control channels between the equipment. However, it is appreciated that DHCP server 104 may be directly connected to only one or a subset of network equipment, while being indirectly connected to other equipment. For example, DHCP server 104 can be directly connected to AP 112 via an Ethernet cable, while being indirectly connected to server 108 (e.g., by relying on an intermediate datapath device such as switch 106). In certain implementations, the functionality and/or equipment for DHCP server 104 can reside within Internet 114 or another network.

In the example environment 100 depicted in FIG. 1, the various network nodes are in the form of intermediary nodes (e.g., switches 106, gateway 102, AP 112), a DHCP server node (e.g., DHCP server 104), and an end user device (device 110). It is appreciated however, that the implementations described herein can be used or adapted for networks including more or fewer devices, different types of devices, and different network arrangements. As an example, in some implementations, DHCP server 104 may operate as an intermediary node or a host device.

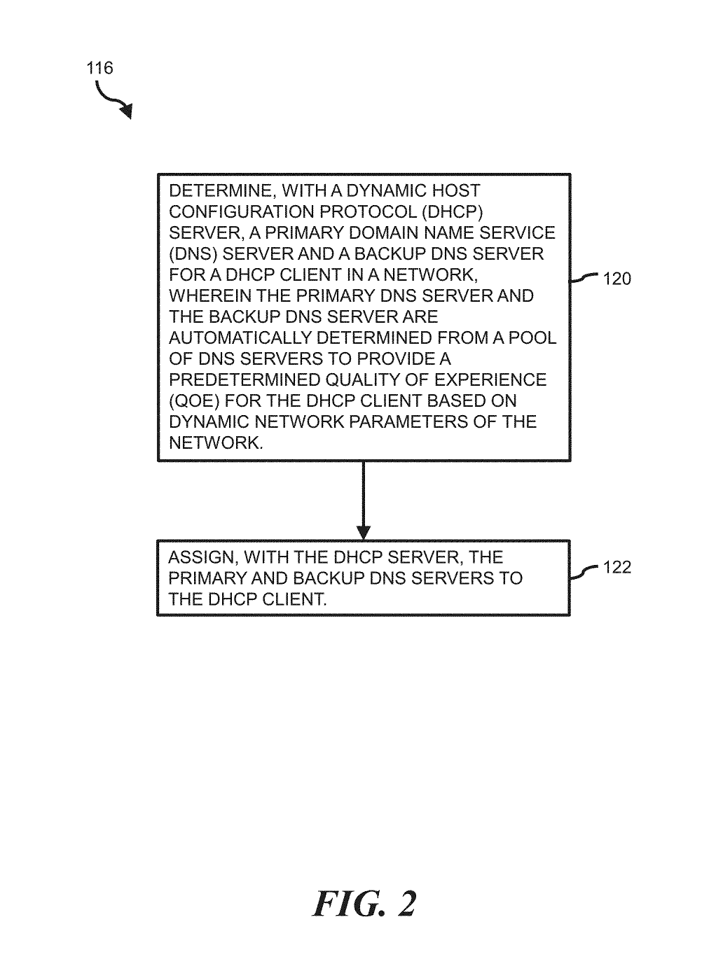

FIG. 2 illustrates an example implementation of the present disclosure. For illustration, the description of method 116 and its component steps make reference to the example network environment 100 of FIG. 1 and elements thereof, such as for example DHCP server 104, DNS servers 118, etc. However, it is appreciated that method 116 or aspects thereof can be used or otherwise applicable for any suitable network or network element described herein or otherwise. For example, method 116 can be applied to an environment 100 with a different number of DNS servers 118, DHCP servers 104, end user devices 110, etc.

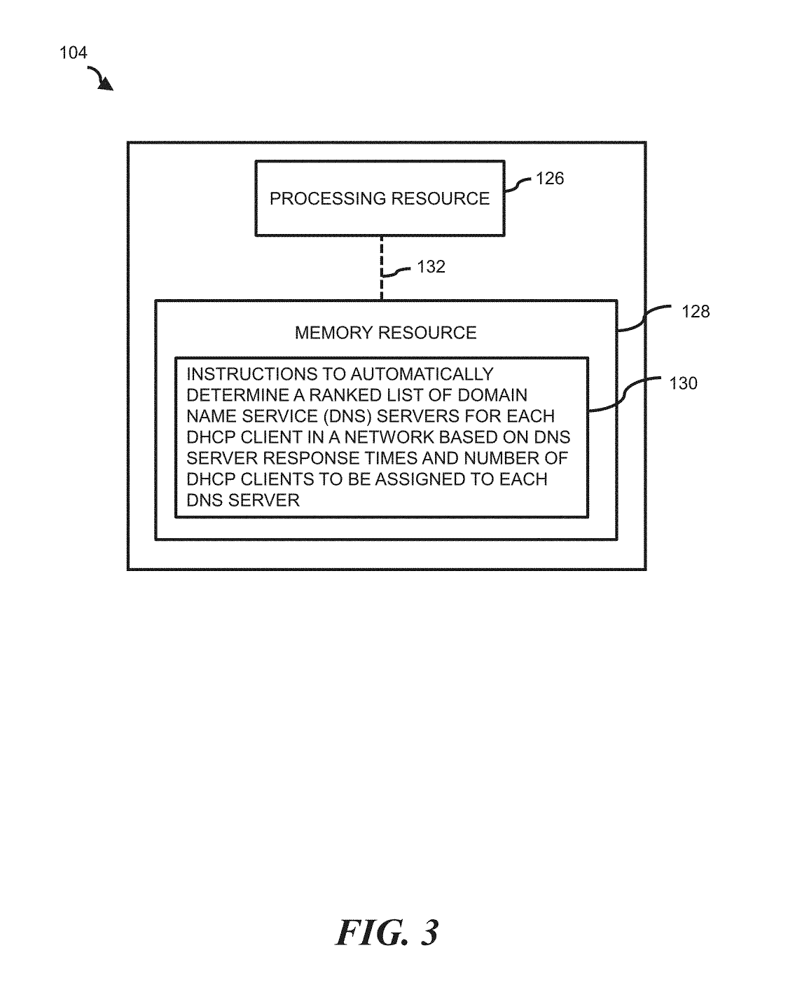

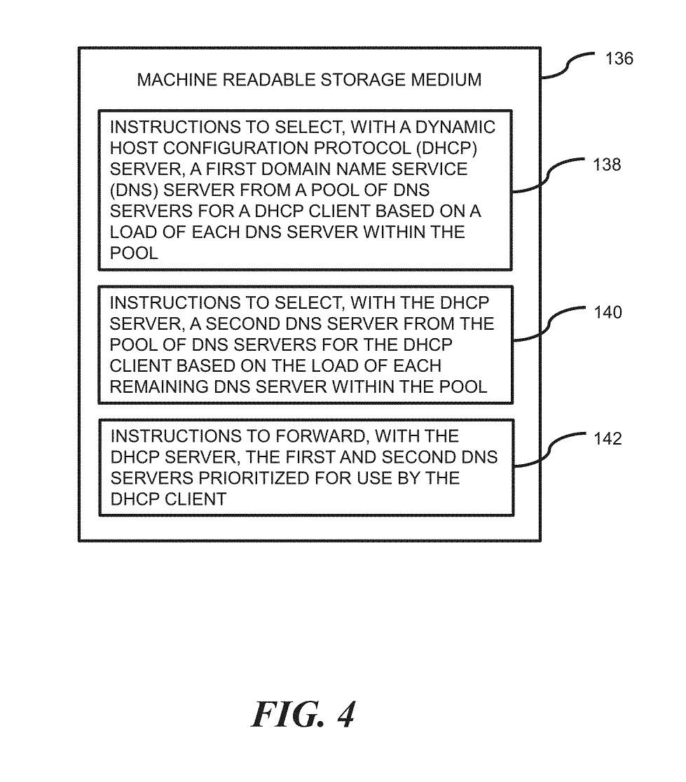

In some implementations, method 116 can be implemented or otherwise executed through the use of executable instructions stored on a memory resource (e.g., the memory resource of the DHCP server of FIG. 3), executable machine readable instructions stored on a storage medium (e.g., the medium of FIG. 4), in the form of electronic circuitry (e.g., on an Application-Specific Integrated Circuit (ASIC)), and/or another suitable form. Although the description of method 116 herein primarily refers to steps performed on DHCP server 104 for purposes of illustration, it is appreciated that in some implementations, method 116 can be executed on another computing device within network environment 100 or in data communication with network environment 100. In some implementations, method 116 can be executed on network devices in parallel (e.g., in a distributed computing fashion).

Method 116 includes determining (at block 120), with DHCP server 104, a primary DNS server and a backup DNS server for a DHCP client in a network. In some implementations, the primary DNS server and the backup DNS server are automatically determined from a pool 124 of DNS servers 118 to provide a predetermined QoE for the DHCP client based on dynamic network parameters of the network.

As used herein, the term “Quality of Experience” and “QoE” can, for example, refer to a measure of a client's experiences with a service. Such a QoE can, for example, be based on the achievement of one or more quality-of-service (“QoS”) metrics. Such, QoS metrics can, for example, refer to acceptable bandwidths, latencies, error rates, response time, jitter rates, and the like. QoE and QoS can, for example, be implemented to help ensure a quality experience when using time-sensitive network services, such as real-time multimedia services including Internet Protocol television (IPTV), video calls, online gaming, security camera streams, Voice over IP (VoIP) traffic, or other services. It is appreciated that a determination whether a configuration that results in a first QoE is better or improved compared to a configuration that results in a second QoE can be based on numerous factors. For example, a first QoE that results from the assignment of a first DNS server to a DHCP client can be determined to be better or improved compared to a second QoE that results from the assignment of a second DNS server to the DHCP client because it provides or is predicted to provide one or more of the following: greater throughput, lower latencies, error, or jitter rates, etc. It is further appreciated that a given DNS server assignment can be determined to be “better” based on other factors, such as a preference of a network administrator.

In some implementations, the primary and backup DNS servers are determined so as to provide the predetermined QoE by load balancing the pool of DNS servers. For example, DHCP server 104 may alternate the assignment of DNS servers based on pool 124 of DNS servers 118. In such an example, a primary DNS server and one or more backup DNS servers may be determined based on a round-robin selection of DNS servers 118 within pool 124. For example, DHCP server 104 may begin by selecting a first DNS server for use by a first client (e.g., server 108) as a preferred DNS server and may select a second DNS server as a backup DNS server for the first client. When a second client (e.g., device 110) requests a DNS server, DHCP server 104 may select the second DNS server as a preferred DNS server for the second client and may select a third DNS server as a backup DNS server for the second client. When a third client requests a DNS server, DHCP server 104 may select the third DNS server as a preferred DNS server for the third client and may select the first DNS server as a backup server for the third client. The following tables depict the differences between a DNS server assignment using a static process and one based on round-robin selection:

TABLE 1
Example static DNS server assignment

| | Preferred DNS Server | Backup DNS server |
|---|---|---|
| Client 1 | DNS server 1 | DNS server 2 |
| Client 2 | DNS server 1 | DNS server 2 |
| Client 3 | DNS server 1 | DNS server 2 |

TABLE 2
Example round-robin DNS server assignment

| | Preferred DNS Server | Backup DNS server |
|---|---|---|
| Client 1 | DNS server 1 | DNS server 2 |
| Client 2 | DNS server 2 | DNS server 3 |
| Client 3 | DNS server 3 | DNS server 1 |

In some implementations, load balancing of DNS servers 118 can, for example, be based on dynamic network parameters of the network. In some implementations, the ranked list of DNS servers are determined so as to normalize response times between DNS servers within a pool of DNS servers. For example, DHCP server 104 may be aware of 1 millisecond (ms) response time for a first DNS server and a 2 ms response time for a second DNS server. If there are three DHCP clients, then the DHCP server may assign two clients to the first DNS server and one client to the second DNS server in an effort to normalize response times between the various DNS servers.

In some implementations, DHCP server 104 can determine DNS server assignments based on a current or predicted load on DNS servers within pool 124. For example, a load on a given DNS server 108 can be determined based on a number of active clients (e.g., clients holding a valid DHCP lease) for a given DNS server. When a client is assigned to a DNS server through DHCP lease, then the active client count for the DNS server may go up by one. When the lease expires, the active client count for the DNS server will go down by one. In some load balancing arrangements, if there are “n” DNS servers and “m” active clients, then DHCP server 104 can seek to maintain an average of m/n clients assigned to each DNS server. Such an assignment process can, for example, be especially useful when there is a mix of short-lived and long-lived clients.

In some implementations, DHCP server can determine DNS servers for use by a DHCP client based on dynamic network parameters for the DHCP client from metadata present in a DHCP discover packet from the client. For example, such a determination can be based on a MAC address or other DHCP options from the DHCP discover packet. In some implementations, the dynamic network parameters can include information relating to one or more user roles for one or more DHCP clients within the network. For example, the user role may indicate whether a given DHCP client is a guest or employee and DHCP server 104 may choose to assign all guest DHCP clients to a first subset DNS servers and all employee DHCP clients to a second subset of DNS servers.

In some implementations, the dynamic network parameters can include information relating to one or more device types for one or more DHCP clients within the network. For example, for wireless devices, the DHCP server may choose a DNS server for a DHCP client based on whether the DHCP client is a mobile phone, a laptop, an IoT device, a printer, surveillance camera, etc. In such an example, DHCP server 104 may assign all smart phones to a first subset of DNS servers, all laptops to a second subset of DNS servers, and all headless devices, such as certain servers or Internet of Things (IoT) devices to a third subset of DNS servers. In some implementations, the dynamic network parameters can include information relating to one or more connection types for one or more DHCP clients within the network, such as the DHCP client is connected via a wireless or wired connection.

In some implementations, the dynamic network parameters can include information relating to a physical location of one or more DHCP clients within the network. For example, DHCP server 104 can prioritize a first DNS server 108 for a DHCP client when it is located on a first floor of a building and can prioritize a second DNS server 108 for the DHCP client when it is located on a second floor of the building. Likewise, DHCP server 104 can prioritize a first DNS server 108 for a DHCP client when it is located within a first building and can prioritize a second DNS server 108 for the DHCP client when it is located in a second building. The location of a DHCP client for this purpose can, for example, be determined based on a wireless access point to which it is connected, or another suitable technique location determination.

Method 116 includes assigning (at block 122) with DHCP server 104, the primary and backup DNS servers to the DHCP client. The assignment of DNS servers can include operations of offering a DHCP server lease, requesting the lease, and acknowledging the lease. Once the DHCP client is assigned to a specific DNS server 108, the DHCP client can be expected to configure its network interface with the negotiated DNS server as well as other parameters. Examples of other DHCP parameters may include router, time server, name server, log server, host name, domain name, etc. It is appreciated that other suitable DHCP options, such as those identified in Internet Engineering Task Force (IETF) Request for Comment (RFC) 2132 can be provided to the DHCP client.

In some implementations, the primary and backup DNS servers assigned to the DHCP client are updated periodically based on changes to the dynamic network parameters or other triggers. For example, in some implementations, one or more of blocks 120 and 122 (or other operations described herein) may be performed periodically. The various period times for blocks 120 and 122 (or other operations described herein) may be the same or different times. For example, in some implementations, the period of block 120 is every 1 minute and the period of block 122 is every 2 minutes. It is further appreciated, that the period for a given block may be regular (e.g., every 1 minute) or may be irregular (e.g., every 1 minute during a first network condition, and every 2 minutes during a second network condition). In some implementations, one or more of block 120 and 122 (or other operations described herein) may be non-periodic and may be triggered by some network or other event.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 116 or other methods described herein in order to achieve the same or comparable functionality. In some implementations, one or more steps are omitted. For example, in some implementations, block 120 of assigning the primary and backup DNS servers 118 can be omitted from method 116 or performed by a device different from the device that determines the primary and backup DNS servers. It is appreciated that blocks corresponding to additional or alternative functionality of other implementations described herein can be incorporated in method 116. For example, blocks corresponding to the functionality of various aspects of implementations otherwise described herein can be incorporated in method 116 even if such functionality is not explicitly characterized herein as a block in method 116.

FIG. 3 is a diagram of a DHCP server 104 in accordance with the present disclosure. DHCP server 104 can, for example, be in the form of a standalone server within network environment 100 or in communication with network environment 100 or equipment thereof. In some implementations, the functionality of DHCP server can be integrated within another computing device, such as for example a network controller. As described in further detail below, DHCP server 104 includes a processing resource 126 and a memory resource 128 that stores machine-readable instructions 130. For illustration, the description of DHCP server 104 makes reference to various aspects of network environment 100 of FIG. 1 as well as method 116 of FIG. 2. However it is appreciated that DHCP server 104 can include additional, alternative, or fewer aspects, functionality, etc., than the implementations described elsewhere herein and is not intended to be limited by the related disclosure thereof.

Instructions 130 stored on memory resource 128 are, when executed by processing resource 126, to cause processing resource 126 to automatically determine a ranked list of DNS servers 118 for each DHCP client in a network based on DNS server response times and number of DHCP clients to be assigned to each DNS server. Instructions 130 can incorporate one or more aspects of blocks of method 116 or another suitable aspect of other implementations described herein (and vice versa). For example, in some implementations, DHCP server 104 can attempt to provide load balancing by seeking to maintain a predetermined average ratio of active clients assigned to a DNS server.

Processing resource 126 of DHCP server 104 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 128, or suitable combinations thereof. Processing resource 126 can, for example, include single or multiple cores on a chip, multiple cores across multiple chips, multiple cores across multiple devices, or suitable combinations thereof. Processing resource 126 can be functional to fetch, decode, and execute instructions as described herein. As an alternative or in addition to retrieving and executing instructions, processing resource 126 can, for example, include at least one integrated circuit (IC), other control logic, other electronic circuits, or suitable combination thereof that include a number of electronic components for performing the functionality of instructions stored on memory resource 128. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 126 can, for example, be implemented across multiple processing units and instructions may be implemented by different processing units in different areas of DHCP server 104.

Memory resource 128 of DHCP server 104 can, for example, be in the form of a non-transitory machine-readable storage medium, such as a suitable electronic, magnetic, optical, or other physical storage apparatus to contain or store information such as machine-readable instructions 130. Such instructions can be operative to perform one or more functions described herein, such as those described herein with respect to method 116 or other methods described herein. Memory resource 128 can, for example, be housed within the same housing as processing resource 126 for DHCP server 104, such as within a computing tower case for DHCP server 104 (in implementations where DHCP server 104 is housed within a computing tower case). In some implementations, memory resource 128 and processing resource 126 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 128 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 128 can be in communication with processing resource 126 via a communication link 132. Each communication link 132 can be local or remote to a machine (e.g., a computing device) associated with processing resource 126. Examples of a local communication link 132 can include an electronic bus internal to a machine (e.g., a computing device) where memory resource 128 is one of volatile, non-volatile, fixed, and/or removable storage medium in communication with processing resource 126 via the electronic bus.

In some implementations, one or more aspects of DHCP server 104 can be in the form of functional modules that can, for example, be operative to execute one or more processes of instructions 130 or 130 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of DHCP server 104 can, for example, include one or more machine-readable storage mediums and one or more computer processors.

In view of the above, it is appreciated various computer-readable instructions of DHCP server 104 described above can correspond to separate and/or combined functional modules. For example, instructions 130 can correspond to a “DNS server selection module” (e.g., module 134 of FIG. 1) to automatically determine a ranked list of DNS servers for each DHCP client in a network based on DNS server response times and number of DHCP clients to be assigned to each DNS server. It is further appreciated that a given module can be used for multiple functions. As but one example, in some implementations, a single module can be used to both determine DNS servers (e.g., corresponding to the functionality of instructions 130) as well as to assign the DNS servers to a DHCP client (e.g., corresponding to the functionality of block 122 of method 116).

One or more nodes within the network environment 100 (e.g., DHCP server 104) can further include a suitable communication module to allow networked communication between network equipment. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other equipment of environment 100. The communication module can, for example, include machine-readable instructions for use with communication the communication module, such as firmware for implementing physical or virtual network ports.

FIG. 4 illustrates a machine-readable storage medium 136 including various instructions that can be executed by a computer processor or other processing resource. In some implementations, medium 136 can be housed within a computing device within network environment 100 to perform the functionality of a DHCP server or in local or remote wired or wireless data communication with network environment 100. For illustration, the description of machine-readable storage medium 136 provided herein makes reference to various aspects of DHCP server 104 (e.g., processing resource 126) and other implementations of the disclosure (e.g., method 116). Although one or more aspects of DHCP server 104 (as well as instructions such as instructions 130) can be applied to or otherwise incorporated with medium 136, it is appreciated that in some implementations, medium 136 may be stored or housed separately from such a system. For example, in some implementations, medium 136 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 136 includes machine-readable instructions 138 stored thereon to cause processing resource 126 to select, with a DHCP server (e.g., DHCP server 104), a first DNS server from a pool (e.g., pool 124) of DNS servers for a DHCP client based on a load of each DNS server within the pool. Instructions 138 can, for example, incorporate one or more aspects of block 120 of method 116 or another suitable aspect of other implementations described herein (and vice versa). For example, in some implementations, a load of a first DNS server 108 can be determined based on a number of active clients using the first DNS server.

Medium 136 includes machine-readable instructions 140 stored thereon to cause processing resource 126 to select, with DHCP server 104, a second DNS server from pool 124 of DNS servers for the DHCP client based on the load of each remaining DNS server within the pool. Instructions 140 can, for example, incorporate one or more aspects of block 120 of method 116 or another suitable aspect of other implementations described herein (and vice versa). For example, in some implementations, a load of a second DNS server 108 can be determined based on a number of active clients using the second DNS server. Medium 136 further includes machine-readable instructions 142 stored thereon to cause processing resource 126 to forward, with DHCP server 104 and as a DHCP lease, first and second DNS servers 118 prioritized for use by the DHCP client. Instructions 142 can, for example, incorporate one or more aspects of block 122 of method 116 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
determining, with a Dynamic Host Configuration Protocol (DHCP) server, a primary Domain Name Service (DNS) server and a backup DNS server for a DHCP client in a network, wherein the primary DNS server and the backup DNS server are automatically determined from a pool of DNS servers to provide a predetermined Quality of Experience (QoE) for the DHCP client based on dynamic network parameters of the network; and
assigning, with the DHCP server, the primary and backup DNS servers to the DHCP client,

2. The method of claim 1, wherein the primary and backup DNS servers are determined so as to provide the predetermined QoE by load balancing the pool of DNS servers.

3. The method of claim 2, wherein load balancing of the DNS servers is based on dynamic network parameters of the network.

4. The method of claim 1, wherein the primary DNS server and the backup DNS server are determined based on a round-robin selection of DNS servers within the pool of DNS servers.

5. The method of claim 1, wherein the dynamic network parameters include response times from each DNS server within the pool of DNS servers.

6. The method of claim 1, wherein the dynamic network parameters include user roles for one or more DHCP clients within the network.

7. The method of claim 6, wherein the user role indicates whether a given DHCP client is a guest or employee.

8. The method of claim 1, wherein the dynamic network parameters include device types for one or more DHCP clients within the network.

9. The method of claim 1, wherein the dynamic network parameters include a number of active clients using a given DNS server within the pool of DNS servers.

10. The method of claim 1, wherein the dynamic network parameters include connection types for one or more DHCP clients within the network.

11. The method of claim 1, wherein the primary and backup DNS servers assigned to the DHCP client are updated based on changes to the dynamic network parameters.

12. A non-transitory machine readable storage medium having stored thereon machine readable instructions to cause a computer processor to:
select, with a Dynamic Host Configuration Protocol (DHCP) server, a first Domain Name Service (DNS) server from a pool of DNS servers for a DHCP client based on a load of each DNS server within the pool; and
select, with the DHCP server, a second DNS server from the pool of DNS servers for the DHCP client based on the load of each remaining DNS server within the pool; and
forward, with the DHCP server and as a DHCP lease, the first and second DNS servers prioritized for use by the DHCP client.

13. The medium of claim 12, wherein a load of a DNS server is determined based on a number of active clients using the DNS server.

14. A Dynamic Host Configuration Protocol (DHCP) server comprising:
a processing resource; and
a memory resource storing machine readable instructions to cause the processing resource to:
automatically determine a ranked list of Domain Name Service (DNS) servers for each DHCP client in a network based on DNS server response times and number of DHCP clients to be assigned to each DNS server.

15. The DHCP server of claim 14, wherein the ranked list of DNS servers are determined so as to normalize response times between DNS servers within a pool of DNS servers.
